(19) United States
(12) Patent Application Publication
(10) Pub. No.: US 2018/0259169 A1
(43) Pub. Date: Sep. 13, 2018

(54) ROTATABLE LIGHT FIXTURE

(71) Applicant: Robert Michel David DuVernet, Slocan (CA)

(72) Inventor: Robert Michel David DuVernet, Slocan (CA)

(21) Appl. No.: 15/452,111

(22) Filed: Mar. 7, 2017

(51) Int. Cl. F21V 21/26; F21V 17/02; F21S 8/06; F21S 6/00; F21V 23/00; F21V 23/06

(52) U.S. Cl. CPC F21V 21/26; F21V 17/02; F21V 23/06; F21S 6/005; F21V 23/001; F21S 8/063

(57) ABSTRACT

An apparatus for providing rotation and connectivity between two members comprises an outer sleeve extending between first and second ends having an inner surface and having a central axis extending lengthwise therethrough, a first end cylindrical bearing, locatable within the outer sleeve along the central axis, the first end cylindrical bearing having an inner surface and a second end cylindrical bearing, locatable within the outer sleeve along the central axis, the second end cylindrical bearing having an inner surface. The apparatus further includes an inner sleeve, locatable within the first end cylindrical bearing along the central axis, the inner sleeve having outer and inner surfaces and a rotatable connector, locatable within the inner sleeve, for rotatably connecting an input and an output through the apparatus.

### BACKGROUND OF THE INVENTION

### 1. Field of Invention

The present invention relates generally to light fixtures and specifically to a light fixture having multiple rotatable arms.

### 2. Description of Related Art

Light fixtures are available in many designs and configurations. Light fixtures with multiple illumination sources are frequently used to illuminate several intended areas or a wider area overall. Lights with several illumination sources may be adjustable to direct light as desired.

One method of adjusting the location of light source is to rotate the light source about its base. A difficulty with rotating a light source is that the wires within may not rotate with the device, limiting rotation and potentially damaging the wires, causing a safety hazard should the wires break and expose the device to uninsulated electrical current.

### SUMMARY OF THE INVENTION

According to a first embodiment of the present invention there is disclosed an apparatus for providing rotation and connectivity between two members comprising an outer sleeve extending between first and second ends having an inner surface and having a central axis extending lengthwise therethrough, a first end cylindrical bearing, locatable within the outer sleeve along the central axis, the first end cylindrical bearing having an inner surface and a second end cylindrical bearing, locatable within the outer sleeve along the central axis, the second end cylindrical bearing having an inner surface. The apparatus further includes an inner sleeve, locatable within the first end cylindrical bearing along the central axis, the inner sleeve having outer and inner surfaces and a rotatable connector, locatable within the inner sleeve, for rotatably connecting an input and an output through the apparatus.

The apparatus may further comprise first and second base plates adjacent to the first and second ends. The first base plate may be secured to the outer sleeve, and the second base plate may be rotatable relative to the outer sleeve. At least one of the first and second base plates may have a central passage along the central axis extending therethrough.

The apparatus may further comprise a threaded fastener positioned to secure the second end cylindrical bearing to the second base plate. The threaded fastener may include a central passage along the central axis extending therethrough. The apparatus may further comprise a nut selected to engage with the threaded fastener. The nut and the threaded fastener may secure the second end cylindrical bearing to the second base plate.

The first end cylindrical bearing may comprise a needle bearing. The inner sleeve may form an inner race for the needle bearing. The second end cylindrical bearing may comprise a thrust bearing.

The apparatus may further comprise an inner spacer locatable between the second base and the second end cylindrical bearing along the central axis. The apparatus may include an end collar rotatably locatable between the second base and the second end cylindrical bearing along the central axis. The end collar may be securable within and to the outer sleeve.

The rotatable connector may be selected from a group consisting of electrical, gas and fluid connectors. The rotatable connector may comprise a rotatable electrical connector. The rotatable electrical connector may include a plurality of wires connected thereto. The wires may extend through the central passage of the threaded fastener, and through at least one of the central passages of said first and second base plates.

The outer sleeve may be rotated relative to the second base plate by a motor secured to the second base plate.

According to a further embodiment of the present invention there is disclosed a rotatable lighting fixture assembly comprising at least one apparatus for providing rotation and connectivity between two members as described above, at least one rigid elongate member, each rigid elongate member extending between first and second ends, including a light source on a bottom surface thereof, a base support extending between proximate and distal ends, the proximate end of the base support rotatably secured to one of the rigid elongate members proximate to the first end; and each rigid elongate member is secured to at least one said apparatus for providing rotation and connectivity between two members proximate to the first end thereof.

According to a further embodiment of the present invention there is disclosed a method for assembling a rotatable lighting fixture assembly comprising providing at least one apparatus for providing rotation and connectivity between two members as described above herein, providing at least one rigid elongate member, each rigid elongate member extending between first and second ends, including a light source on a bottom surface thereof, and providing a base support extending between proximate and distal ends. The method further comprises rotatably securing the proximate end of the base support to one of the rigid elongate members proximate to the first end thereof; and securing each of the rigid elongate members to at least one of the apparatus for providing rotation and connectivity between two members proximate to the first end thereof.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In drawings which illustrate embodiments of the invention wherein similar characters of reference denote corresponding parts in each view,

FIG. 1 is a perspective view of a rotatable light fixture according to a first embodiment of the present invention.

FIG. 2 is an exploded perspective view of the pivoting riser assembly of the light fixture of FIG. 1.

FIG. 3 is a cross-sectional view of the pivoting riser assembly of FIG. 2 along the plane 3-3.

FIG. 4 is a perspective view of the pivoting riser assembly of FIG. 2 according to a further embodiment of the present invention.

FIG. 5 is a perspective view of a rotatable light fixture according to a further embodiment.

### DETAILED DESCRIPTION

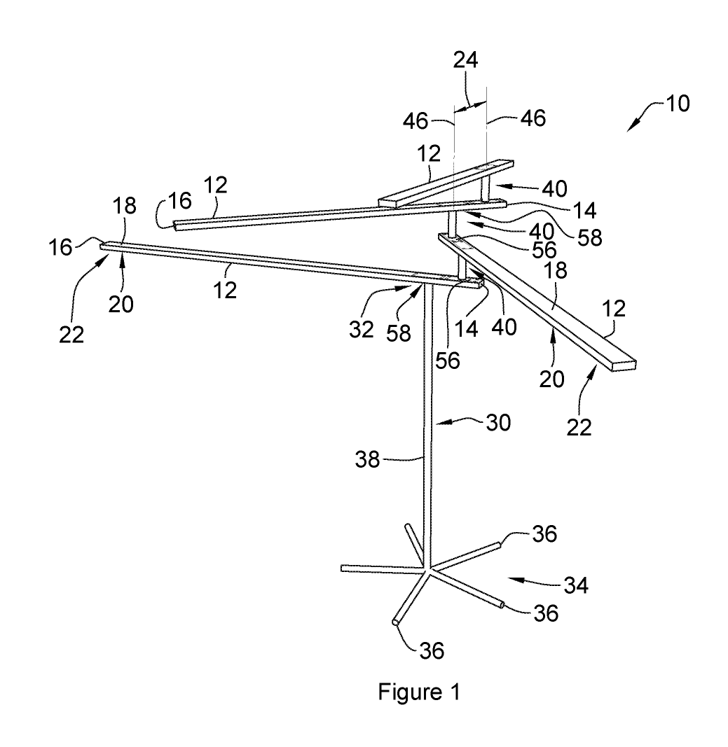

Referring to FIG. 1, a rotatable light fixture according to a first embodiment of the invention is shown generally at 10. The light fixture 10 comprises a plurality of rotatable arms 12 connected together with a plurality of pivoting riser assemblies 40. The fixture further includes a base support 30 rotatably secured to one of the rotatable arms 12.

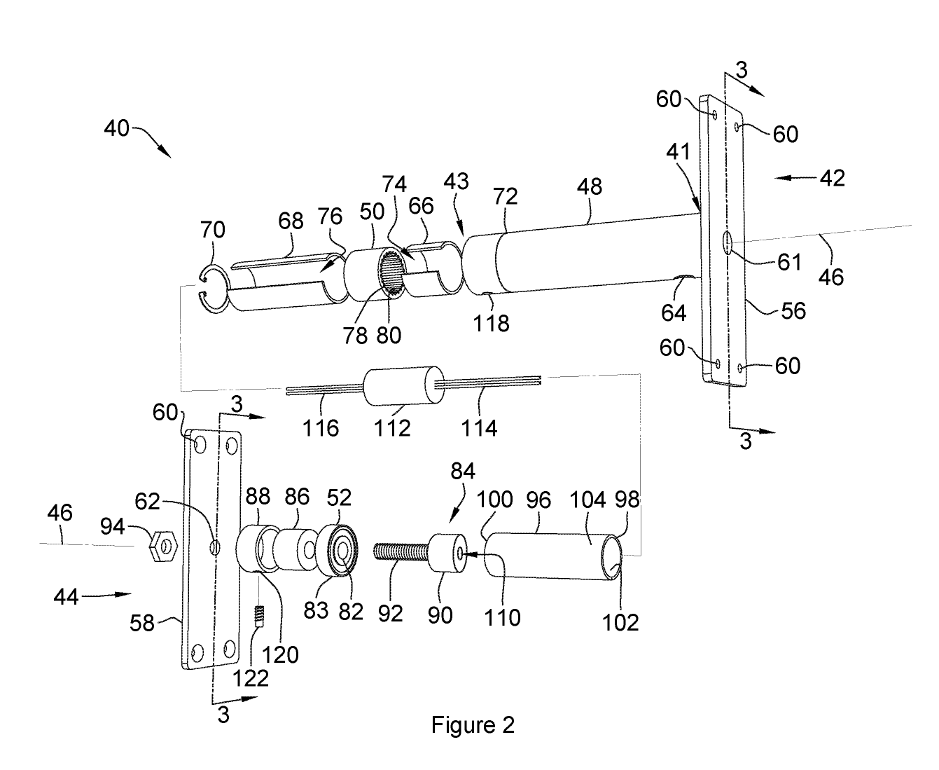

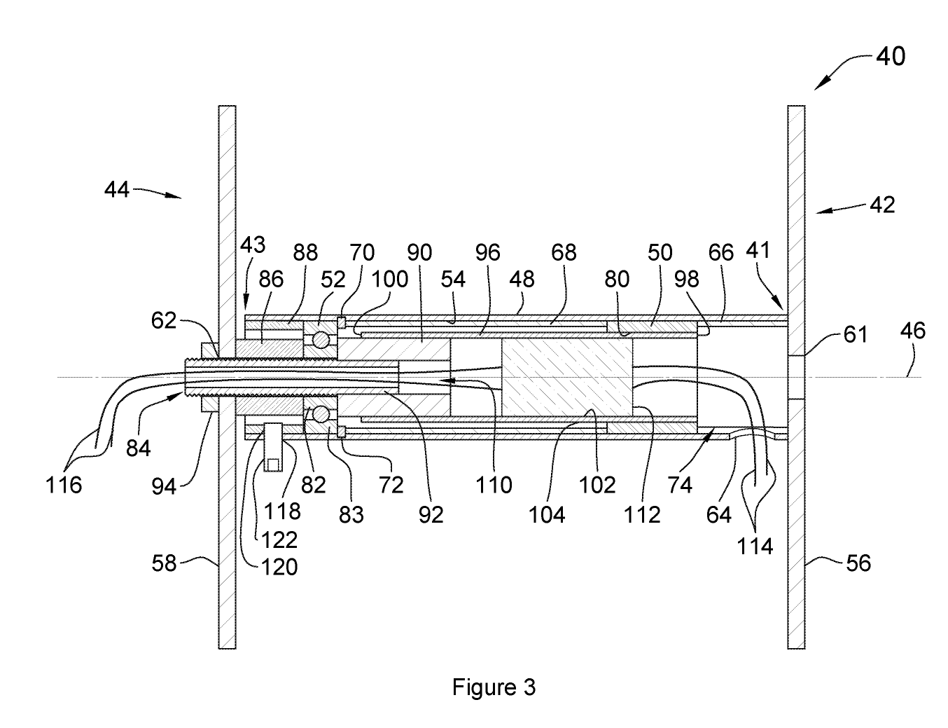

Turning to FIGS. 2 and 3, each pivoting riser assembly 40 extends between first and second ends, 42 and 44, respectively along a central axis 46. Each riser assembly 40 includes a cylindrical outer sleeve 48, with first and second cylindrical bearings, 50 and 52, respectively, therein. The outer sleeve 48, extends between first and second ends, 41 and 43, respectively, and includes an inner surface 54. The riser assembly 40 includes a first base plate 56 secured to the first end 41 and a second base plate 58 proximate to the second end 43. The outer sleeve 48 may be secured to the first base plate 56 by any known means, such as, by way of non-limiting example, welding or adhesive, or it may be co-formed with the first base plate 56. The rectangular planar first and second base plates, 56 and 58, include a plurality of mounting holes 60 therethrough. The first and second base plates, 56 and 58, also include first and second central holes, 61 and 62, respectively, therethrough, centred on the central axis 46, the purpose of which will be set out below. The outer sleeve 48 includes an optional first end hole 64 extending radially through the outer sleeve 48 proximate to the first end 41, and a second end hole 118 extending radially through the outer sleeve proximate to the second end 43, as illustrated in FIGS. 2 and 3.

The first cylindrical bearing 50 includes an inner surface 80 and is located within the outer sleeve 48, along the central axis 46, between first and second outer sleeve spacers, 66 and 68, respectively. Optionally, the one or both of the first or second outer sleeve spacer 66 or 68 may be omitted and a ridge or other structure provided to locate the first cylindrical bearing 50. A retaining ring, 70, as is commonly known, retains first and second outer sleeve spacers 66 and 68 and the first cylindrical bearing 50 within the outer sleeve 48. The retaining ring 70 engages within a circumferential groove 72 on the inner surface 54 of the outer sleeve 48. The first and second outer sleeve spacers 66 and 68 are cylindrical and include first and second axial openings, 74 and 76, respectively. The first and second axial openings 74 and 76 allow for ease of installation and such that wires may pass therethrough, as will be described further below. The first and second outer sleeve spacers 66 and 68 and the first cylindrical bearing 50 are sized to engage upon the inner surface 54 of the outer sleeve 48. The first cylindrical bearing 50 may be a needle bearing, as is commonly known, with a plurality of axial rollers 78 on the inner surface 80 thereof, as best seen in FIG. 2, although other types of bearings, such as, by way of non-limiting example, bushings, roller bearings or the like may be useful, as well.

The second cylindrical bearing 52 includes inner and outer races, 82 and 83, respectively. A hollow threaded fastener 84 secures the second cylindrical bearing 52 to the second base plate 58 along the central axis 46. A cylindrical inner spacer 86 is located between the second cylindrical bearing 52 and the second base plate 58. A cylindrical end collar 88 is sized to fit around the inner spacer 86 and engage within the outer sleeve 48, as will be described more fully below. The cylindrical end collar 88 includes a radial mounting hole 120 therethrough, selected to match the second end hole 118 through the outer sleeve 48. A set screw 122 is selected to engage within the second end hole 118 and mounting hole 120, as will be set out below. The hollow threaded fastener 84 comprises a cylindrical head 90 and a shaft 92 with a cylindrical passage 110 along the central axis 46 therethrough. The shaft 92 engages within the cylindrical head 90, as best shown in FIG. 3. A nut 94 is sized to engage upon threading on the shaft 92 of the hollow threaded fastener 84 proximate to the second end 44. The threaded fastener 84 and nut 94 secure the second cylindrical bearing 52 and inner spacer 86 to the second base plate 58 through the second central hole 62. Optionally, the shaft 92 may be secured to the second base plate 58 through any other means as are commonly known, such as, by way of non-limiting example, welding, adhesives or the like. The inner race 82 remains stationary relative to the second base plate 58 during operation, as will be set out below. The second cylindrical bearing 52 is sized such that the outer race 83 engages upon the inner surface 54 of the outer sleeve 48. Optionally, the second cylindrical bearing may be substantially fluidically sealed against the outer sleeve 48 and to the threaded fastener 84 so as to seal the interior of the assembly from the exterior thereof.

A cylindrical inner sleeve 96, includes inner and outer surfaces 102 and 104, respectively, and extends along the central axis 46 between first and second ends, 98 and 100, respectively. The inner sleeve 96 is sized such that the inner surface 102 engages upon the cylindrical head 90 of the hollow threaded fastener 84 proximate to the second end 100 and thus remains stationary relative to the second base plate 58 during operation. It will be appreciated that the inner sleeve 96 and the hollow threaded fastener 84 may be separate parts, as shown, or they may be co-formed. The outer surface 104 of the inner sleeve 96 engages upon the inner surface 80 of the first cylindrical bearing 50 proximate to the first end 98, such that the inner sleeve 96 forms the inner race of the bearing, as is commonly known. During operation, the outer sleeve 48 may rotate relative to the inner sleeve 96 and second base plate 58. When assembled, the first end 98 is aligned within the first cylindrical bearing 50 and the second end 100 is located proximate to the second cylindrical bearing 52, as best seen on FIG. 3.

A rotatable connector 112 is located within the cylindrical inner sleeve 96, with a plurality of first and second end wires, 114 and 116, connected thereto. The rotatable connector 112 may be a rotatable electric connector, as is commonly known and as illustrated in the present embodiment, although it may be appreciated that the rotatable connector 112 may be a fluid or gas connector, with piping or tubing in place of the wires 114 and 116. The first end wires 114 may pass through the first end hole 64, as illustrated in FIG. 3, or they may optionally pass through the first central hole 61 proximate to the first end 41. The second end wires 116 pass through the cylindrical passage 110, to the exterior of the pivoting riser assembly 40 proximate to the second end 44.

To assemble the pivoting riser assembly 40, all parts previously described herein are assembled as described above and as illustrated in FIG. 3, noting that the first outer sleeve spacer 66 is rotated such that the first axial opening 74 is aligned with the first end hole 64 to allow the first end wires 114 to pass therethrough proximate to the first end 42. Proximate to the second end 44, the outer race 83 of the second cylindrical bearing 52 is engaged upon the inner surface 54 of the outer sleeve 48 such that the outer race 83 remains stationary relative to the outer sleeve 48, and is located adjacent to the retaining ring 70. The cylindrical end collar 88 is positioned within the outer sleeve 48 proximate to the second end 44 such that the second end hole 118 and the mounting hole 120 are aligned, and retaining the second cylindrical bearing 52 within the outer sleeve 48. The set screw 122 engages within the second end hole 118 and the mounting hole 120 to secure the cylindrical end collar 88 within the outer sleeve 48 and thereby retaining the parts described above within the outer sleeve 48. The set screw 122 may also engage upon the inner spacer 86, adding friction and limiting or eliminating the free rotation of the device. As assembled, the outer sleeve 48 and attached first base plate 56 rotate about the central axis 46 relative to the second base plate 58.

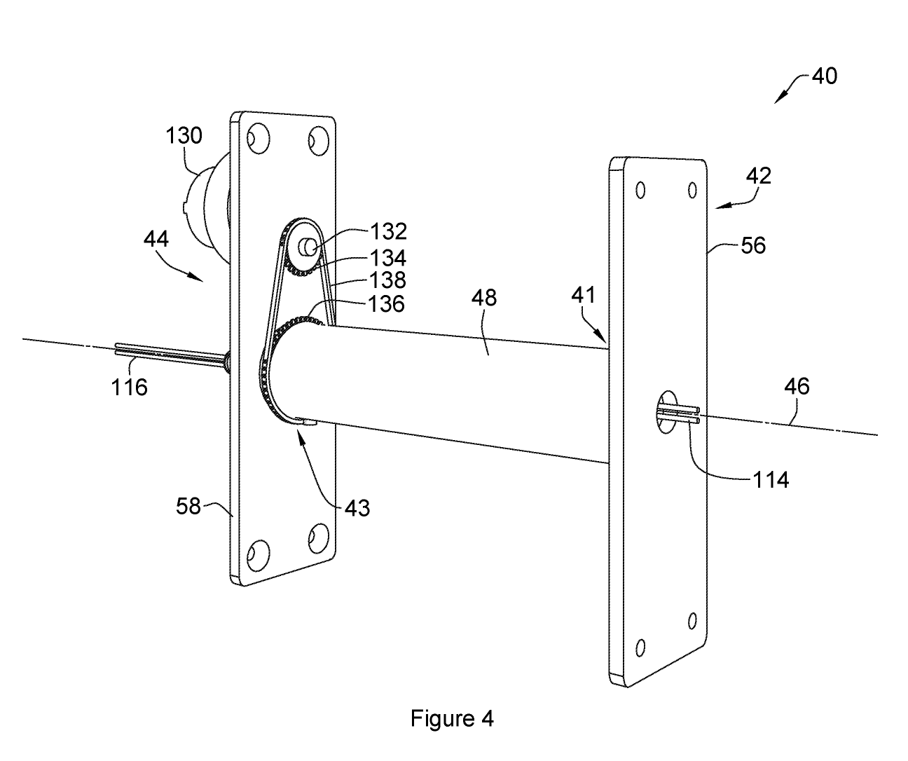

FIG. 4 illustrates a further embodiment wherein the pivoting riser assembly 40 first base plate 56 may be rotated about the central axis 46 relative to the second base plate 58 with an electric motor 130. The motor 130 may be of any conventional type, as is commonly known. The motor 130 is attached to the second base plate 58 at the second end 44 and rotates a shaft 132 which extends through a hole (not shown) in the second base plate 58. A drive gear 134 is rotated by the shaft 132. A driven gear 136 is fixed to the outer sleeve 48 proximate to the second end 43. The drive gear 134 rotates the driven gear 136 with a drive belt 138, as is commonly known. Power may be supplied to the motor 130 using the second end wires 116 using methods as commonly known.

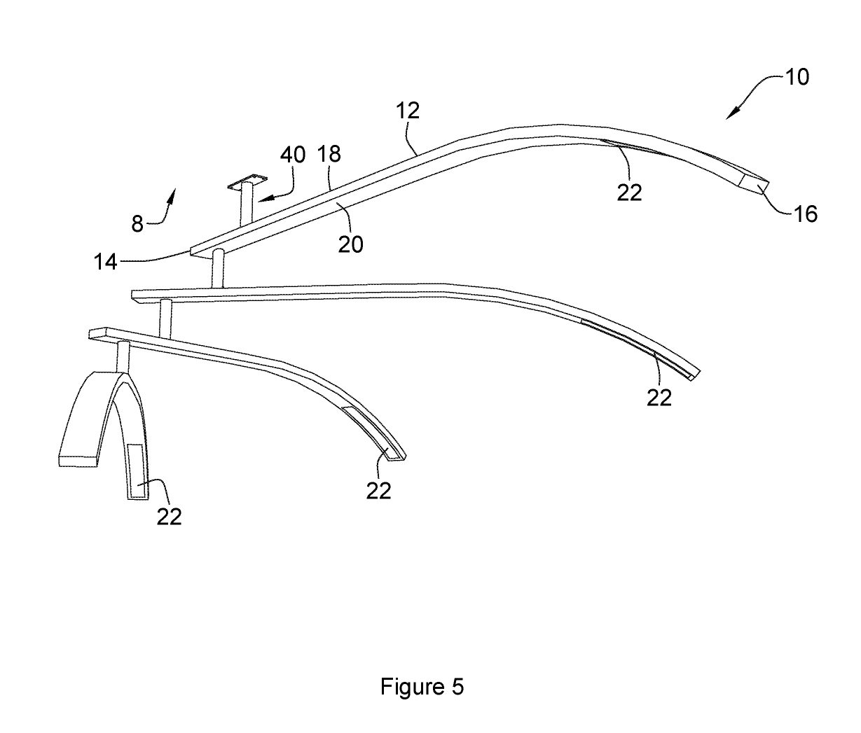

Turning now to FIG. 1, each elongate rotatable arm 12 includes top and bottom surfaces, 18 and 20, respectively, and extends between first and second ends, 14 and 16, respectively. It will be appreciated that each rotatable arm 12 may be substantially planar, as illustrated in FIG. 1, or each rotatable arm 12 may be formed with other profiles, such as curved, as illustrated in FIG. 5. When each rotatable arm 12 is curved, the curvature is selected such that the rotatable arms 12 do not interfere with each other during operation.

As best seen on FIG. 5, each rotatable arm 12 includes a light source 22, as is commonly known, illuminating from the bottom surface 20 thereof, proximate to the second end 16. Wires (not shown) to power the light sources 22 may extend between the light source 22 and the first end 14 within the rotatable arm 12.

Each rotatable arm 12 is connected to at least one other rotatable arm 12 with a pivoting riser assembly 40. As illustrated in FIG. 1, the first base plate 56 is mounted to the top surface 18 of a rotatable arm 12 proximate to the first end 14, and the second base plate 58 is mounted to the bottom surface 20 of a rotatable arm 12 proximate to the first end 14. As shown in the present embodiment, each pivoting riser assembly 40 is mounted to each rotatable arm 12 such that the central axis 46 of the pivoting riser assembly 40 secured to the top surface 18 may be offset from the central axis 46 of the pivoting riser assembly 40 secured to the bottom surface 20 by an offset distance 24 sufficient to balance each rotatable arm 12 as supported thereby.

Referring to FIG. 1, the base support 30 is formed in a similar manner to the pivoting riser assembly 40 and extends between proximate and distal ends, 32 and 34, respectively. The base support 30 includes an extended outer sleeve 38 replacing the outer sleeve 48, and a plurality of legs 36 replacing the first base plate 56. As described for the pivoting riser assembly 40 above, the base support 30 includes a second base plate 58 at the proximate end 32 thereof, which is mounted to the bottom surface 20 of a rotatable arm 12, allowing the attached rotatable arm 12 to rotate relative to the extended outer sleeve 38 and legs 36. It will also be appreciated that the pivoting riser assembly 40 may be utilized between a single rotatable arm 12 and a stationary surface such as a floor or ceiling by way of non-limiting example.

Wires (not shown) are connected, as is commonly known, from each light source 22 to the wires within each riser assembly 40. Connected wires extend through the base support 30 to a power supply (not shown).

Turning now to FIG. 5, a further embodiment is illustrated wherein the light fixture 10 is suspended from a ceiling 8 by mounting a pivoting riser assembly 40 thereto. Power is supplied through the ceiling 8 as is commonly known for ceiling lights.

While specific embodiments of the invention have been described and illustrated, such embodiments should be considered illustrative of the invention only and not as limiting the invention as construed in accordance with the accompanying claims.

What is claimed is:

1. An apparatus for providing rotation and connectivity between two members comprising:
an outer sleeve extending between first and second ends having an inner surface and having a central axis extending lengthwise therethrough;
a first end cylindrical bearing, locatable within said outer sleeve along said central axis, said first end cylindrical bearing having an inner surface;
a second end cylindrical bearing, locatable within said outer sleeve along said central axis, said second end cylindrical bearing having an inner surface;
an inner sleeve, locatable within said first end cylindrical bearing along said central axis, said inner sleeve having outer and inner surfaces; and
a rotatable connector, locatable within said inner sleeve, for rotatably connecting an input and an output through said apparatus.

2. The apparatus of claim 1 further comprising first and second base plates adjacent to said first and second ends.

3. The apparatus of claim 2 wherein said first base plate is secured to said outer sleeve, and wherein said second base plate is rotatable relative to said outer sleeve.

4. The apparatus of claim 2 wherein at least one of said first and second base plates has a central passage along said central axis extending therethrough.

5. The apparatus of claim 1 further comprising a threaded fastener positioned to secure said second end cylindrical bearing to said second base plate.

6. The apparatus of claim 5 wherein said threaded fastener includes a central passage along said central axis extending therethrough.

7. The apparatus of claim 5 further comprising a nut selected to engage with said threaded fastener, wherein said nut and said threaded fastener secure said second end cylindrical bearing to said second base plate.

8. The apparatus of claim 1 wherein said first end cylindrical bearing comprises a needle bearing.

9. The apparatus of claim 8 wherein said inner sleeve forms an inner race for said needle bearing.

10. The apparatus of claim 1 wherein said second end cylindrical bearing comprises a thrust bearing.

11. The apparatus of claim 1 further comprising an inner spacer locatable between said second base and said second end cylindrical bearing along said central axis.

12. The apparatus of claim 1 further comprising an end collar rotatably locatable between said second base and said second end cylindrical bearing along said central axis.

13. The apparatus of claim 12 wherein said end collar is securable within and to said outer sleeve.

14. The apparatus of claim 1 wherein said rotatable connector is selected from a group consisting of electrical, gas and fluid connectors.

15. The apparatus of claim 14 wherein said rotatable connector comprises a rotatable electrical connector.

16. The apparatus of claim 15 wherein said rotatable electrical connector includes a plurality of wires connected thereto.

17. The apparatus of claim 16 wherein said wires extend through said central passage of said threaded fastener, and through at least one of said central passages of said first and second base plates.

18. The apparatus of claim 1 wherein said outer sleeve is rotated relative to said second base plate by a motor secured to said second base plate.

19. A rotatable lighting fixture assembly comprising:
at least one apparatus for providing rotation and connectivity between two members as described herein claim 1;
at least one rigid elongate member, each said rigid elongate member extending between first and second ends, including a light source on a bottom surface thereof;
a base support extending between proximate and distal ends, wherein said proximate end of said base support is rotatably secured to one of said rigid elongate members proximate to the first end thereof; and
wherein each said rigid elongate member is secured to at least one said apparatus for providing rotation and connectivity between two members proximate to the first end thereof.

20. A method for assembling a rotatable lighting fixture assembly comprising:
providing at least one apparatus for providing rotation and connectivity between two members as described in claim 1;
providing at least one rigid elongate members, each said rigid elongate member extending between first and second ends, including a light source on a bottom surface thereof;
providing a base support extending between proximate and distal ends;
rotatably securing said proximate end of said base support to one of said rigid elongate members proximate to the first end thereof; and
securing each of said rigid elongate members to at least one of said apparatus for providing rotation and connectivity between two members proximate to the first end thereof.
